(19) United States
(12) Patent Application Publication
(10) Pub. No.: US 2025/0271323 A1
(43) Pub. Date: Aug. 28, 2025

(54) DEVICES AND RELATED METHODS FOR MEASURING GAS PERMEATION OF PIPES AND VESSELS

(71) Applicant: IQ4H2, LLC, JACKSONVILLE, FL (US)

(72) Inventors: MICHAEL PETERS, CENTENNIAL, CO (US); KENT WEISENBERG, JACKSONVILLE, FL (US); CORY KREUTZER, ARVADA, CO (US)

(73) Assignee: IQ4H2, LLC, JACKSONVILLE, FL (US)

(21) Appl. No.: 19/058,394

(22) Filed: Feb. 20, 2025

Related U.S. Application Data
(60) Provisional application No. 63/556,609, filed on Feb. 22, 2024.

(51) Int. Cl. G01M 3/10

(52) U.S. Cl. CPC G01M 3/10

(57) ABSTRACT

Disclosed herein are devices and related methods for measuring the permeation of a gas, including hydrogen, of a pipe or pipe liner. A sealed vessel for permeation testing is contained within the device, and immersed within a volume of liquid. Leakage of gas from the sealed vessel during testing produces bubbles, which are captured by the device. The amount of gas which leaks from the sealed vessel can thereby be readily and accurately determined.

### CROSS REFERENCE TO RELATED APPLICATIONS

This application claims priority to U.S. Provisional Patent Application Ser. No. 63/556,609, filed on Feb. 22, 2024, and titled “Devices and Related Methods for Measuring Gas Permeation of Pipes and Vessels,” the disclosure of which is incorporated herein by reference.

### FIELD

Disclosed herein are devices and related methods for measuring the permeation of a gas, including hydrogen, of a pipe or pipe liner.

### BACKGROUND

The use of sealed vessels is widespread in industry, for both the storage and the transmission of gases. Ideally, a sealed vessel used to contain a gas is completely impermeable to the gas, and leakage of gas from the vessel is entirely eliminated. However, engineering and economic factors can preclude the manufacture and use of perfectly impermeable vessels, which may be excessively bulky or unwieldy for practical purposes. Potential leakage from actual manufactured vessels must be acknowledged, and methods to measure this leakage are required, not only for economic reasons, i.e., loss of product, but also for reasons of safety and hazard mitigation. This is particularly true for noxious or flammable gases, whose leakage can pose a significant risk to surrounding areas.

In certain embodiments, the sealed vessel contains or transports a flammable gas, including but not limited to hydrogen. While the actual permeation rate of hydrogen through a pipe, pipe liner, or storage vessel is important for safety reasons, it is also highly important for financial reasons. Gas that leaks from the vessel represents gas that is not delivered to the customer. Owners/operators go to great expense to compress the gas, so gas escaping into the atmosphere is not cost effective for them. Furthermore, loss of gas would need to be taken into account when planning systems for transmission of gas. The primary purpose of high pressure rated pipes, liners and vessels is to be able to store compressed hydrogen to make its transmission or storage economical as it relates to its energy density. For example, the volumetric energy density of hydrogen is 3× less than that of natural gas, so while the relationship is not linear, hydrogen must be compressed approximately 3× more to provide the same energy per unit volume. More importantly, pipeline owners and operators are required to mitigate the risks associated with the release of gas through release mechanisms such as permeation. A pipeline, liner, or vessel with significant permeation will require higher cost and more involved risk mitigation efforts. This, in turn, diminishes the cost benefits of hydrogen, as the cost in money and manpower required for mitigation will make hydrogen less attractive to owners and operators.

For this reason, industry relies on methods that measure gas permeation through samples of the material used to fashion the sealed vessel. Typically, material permeation tests are done with testing systems that employ discs, coupons, or sheets of the relevant material. Permeation and/or diffusion of gas across a pressure gradient can be measured. From these measurements, estimates for gas leakage from a sealed vessel can be calculated.

However, the industry lacks methods for accurately measuring gas leakage from actual field ready specimens. This deficiency is significant, since it has been demonstrated that permeation rates through testing assemblies can vary wildly from permeation rates through a shaped vessel. Furthermore, the industry lacks reliable equations or algorithms to extrapolate leakage data from testing of a disc, coupon, or sheet material test to real world pipes or pipe liners. This discrepancy creates significant uncertainty in assessing the environmental impact and hazards, as well as determination of the need to employ mitigative measures.

Current methods for permeation testing are clearly inadequate for current needs. Currently available testing methods that rely on a disc, coupon, or sheet do not fully replicate the sealed vessel assembly in operation. Data collected for a material tested with any of these existing methods must include a factor of reduction of permeation when used for a real-world pipe, liner or vessel. This factor will be much lower for safety reasons, accounting for a margin of error. In essence, the risk mitigation based on coupon/disc/sheet testing may be significantly higher than needed.

Finally, methods that have been developed for material resistance (e.g., those used in the natural gas or liquid markets) may be inadequate for hydrogen service due to the unique properties of hydrogen such as its relatively small molecular size.

There remains a need for devices and related methods to accurately and reliably measure the rate of gas permeation from field ready vessels intended for the storage and/or transmission of gases.

### SUMMARY

Accordingly, provided herein is a testing apparatus for measuring the permeation of gas from a sealed vessel. The testing apparatus comprises a fixture, which in turn comprises an enclosure, which surrounds the entirety of the sealed vessel.

The testing apparatus optionally contains an opening at the bottom. This opening can serve either or both of two purposes: it can allow entry and egress of a sealed vessel into the interior of the enclosure, and/or it can provide a pathway from the interior of the enclosure to the exterior.

The fixture further provides one or more inverted funnels, extending upward from the enclosure, each of which is fused with the enclosure. An interior volume for the fixture can be defined, consisting of the volume of the enclosure and the volumes of each of the one or more inverted funnels.

Measurement of gas permeation can be accomplished as follows. The enclosure is positioned on the sealed vessel, which in turn is located in a reservoir filled with a liquid, most conveniently water. The enclosure is positioned at or above the floor of the reservoir. The water level is sufficiently high to completely immerse both a bottom opening of the enclosure and the sealed vessel within the enclosure.

In the initial state, each of the one or more inverted funnels is completely filled with water. This can be accomplished with any suitable step, including but not limited to a positive flow of water to the interior of the enclosure, or application of suction to draw water from the reservoir into the funnel. The sealed vessel is then pressurized with the gas of interest, including but not limited to hydrogen.

At this point, leakage of gas from the scaled vessel will form bubbles which, being less dense than the liquid, will rise to the top of the testing apparatus. Each of the one or more funnels will collect the bubbles that form and ascend beneath it. Over time, a gaseous headspace can form at the top of each of the one or more funnels, the volume of which will depend on the degree of gas leakage below the particular funnel.

The volume of leaked gas can be determined from the level of the water and the geometry of the funnel. More conveniently, a burette is located on the top of each funnel. The burette, consisting of a vertically oriented tube, can provide a means to directly measure the volume of gas.

Since water, like most liquids, is essentially incompressible, formation of a gaseous headspace above the water in the fixture will require that water flow out of the fixture, and into the surrounding reservoir. The testing apparatus therefore provides one or more pathways to accommodate this flow. This can be accomplished by maintaining a gap between the bottom of the enclosure and the floor of the reservoir. Alternatively, the walls of the enclosure may contain perforations, through which water can pass. Preferably, gas bubbles will not pass through these pathways. This can most easily be accomplished by locating the pathways at or below the level of the sealed vessel.

The use of vertically oriented cylinders in place of funnels is contemplated with this disclosure. However, it will be apparent that the use of funnels can provide a “rain-gauge” improvement in precision. A large opening at the bottom of a funnel can collect leakage from a large portion of the sealed vessel. The gas that is collected over a period of time can be directed into the narrow upper terminus of the funnel, thereby providing a tall and narrow cylinder of gas that can be easily measured through volumetric displacement.

During the measurement procedure, the bottom opening of the enclosure remains immersed within the reservoir, thereby preventing any leaked gas bubbles from escaping to the exterior, while still maintaining equilibrium between the liquid within the enclosure and outside of the enclosure.

In certain embodiments, it may be beneficial to quantify the composition of the gas accumulated in the funnel segment. This may be useful when performing permeation evaluation of hydrogen and natural gas blends, or other gas mixtures. In this embodiment, once the permeation rate of the gas mixture is measured, the released gas can be routed to a gas chromatograph or other chemical composition analysis method common to the chemical industry to provide chemical species and concentration.

Testing of sealed vessels with the testing apparatus disclosed herein will provide higher quality data on real-world performance of these vessels. Operators will know exactly how their material will perform in the field, and thus will be able to set realistic risk mitigation measures. Improved prediction of real-world performance can reduce the magnitude of the safety factor, thus saving the operator significant effort and expense. Finally, the improved testing will significantly help owners, operators, manufacturers etc. with the regulatory approval process of new or revised materials and products. These stakeholders will no longer have to “guess” at the hydrogen permeation rate of their materials in the field which will expedite the approval process.

### BRIEF DESCRIPTION OF THE DRAWINGS

A full understanding of the invention can be gained from the following description of the preferred embodiments when read in conjunction with the accompanying drawings in which:

FIG. 1 provides a perspective of a testing apparatus with a single funnel, according to an embodiment disclosed herein;

FIG. 2 provides a top view of a testing apparatus, according to an embodiment disclosed herein;

FIG. 3 provides a side view of a testing apparatus with a single funnel, according to an embodiment disclosed herein;

FIG. 4A depicts an end view of a testing apparatus, FIG. 4B depicts an initial step in the operation of the apparatus, and FIGS. 4C and 4D depict subsequent steps in the operation of the apparatus, according to an embodiment disclosed herein;

FIG. 5 provides a side view of a testing apparatus with a single funnel in an initial testing state, according to an embodiment disclosed herein;

FIG. 6 provides a side view of a testing apparatus with a single funnel in a subsequent testing state, according to an embodiment disclosed herein;

FIG. 7 provides a side view of a testing apparatus with a single funnel during a testing procedure, according to an embodiment disclosed herein; and

FIG. 8 provides a perspective view of a testing apparatus with three funnels, according to an embodiment disclosed herein;

FIG. 9 provides a side view of a testing apparatus with three funnels, according to an embodiment disclosed herein;

FIG. 10 provides a side view of an embodiment comprising multiple funnels in an initial testing state, according to an embodiment disclosed herein;

FIG. 11 provides a side view of an embodiment comprising multiple funnels during a testing procedure, according to an embodiment disclosed herein; and

FIG. 12A depicts means for exchanging water between the interior volume and the reservoir in an embodiment with a fixture comprising an enclosure and funnel assembly positioned over a sealed vessel, and FIG. 12B depicts an embodiment with a fixture comprising an enclosure that is equipped with two baffles that divide the interior volume into three sub-volumes which are covered by respective funnel assemblies.

### DETAILED DESCRIPTION OF PREFERRED EMBODIMENTS

Accordingly, in one aspect is provided a testing apparatus for measuring the permeation of a gas from a sealed vessel, the testing apparatus comprising a fixture, the fixture comprising:
an enclosure; and
one or more funnel assemblies located on a top of the enclosure, each of the one or more funnel assemblies comprising:
   a funnel extending vertically from the top of the enclosure, the funnel having a narrow end oriented distal from the enclosure;
   a burette at a distal end of the funnel, the burette comprising a closable valve at a distal end of the burette;
   wherein the funnel forms a single liquid-impermeable junction with the enclosure and the burette forms a single liquid-impermeable junction with the funnel;
wherein the fixture includes a liquid impermeable interior surface comprising a union of an interior surface of the enclosure and an interior surfaces of each of the one or more funnel assemblies, the interior surface of the enclosure defining a contiguous interior volume of the fixture sized to receive an entirety of the sealed vessel.

In some embodiments, for any location on the interior surface of the enclosure, there exists at least one path along the interior surface of the enclosure to a junction with a funnel, wherein the entire path from the location to the junction is at all points level or upwards.

In some embodiments, there exists no spot on the interior surface of the enclosure that is at a local maximum in height.

In some embodiments, the funnel of at least one of the funnel assemblies is impermeable to liquid. In some embodiments, the funnel of each of the of the funnel assemblies is impermeable to liquid.

In some embodiments, the enclosure has an opening at the bottom of the enclosure. In some embodiments, the enclosure comprises one or more doors at the bottom of the enclosure that allow for entry and egress of the sealed vessel.

In some embodiments, the enclosure is impermeable to liquid above a level located at or below the bottom of the sealed vessel. In some embodiments, the enclosure is impermeable to liquid. In some embodiments, the enclosure comprises one or more perforations.

In some embodiments, the one or more perforations are located at or below the bottom of the sealed vessel.

In some embodiments, the testing apparatus further comprises:
one or more baffles, each comprising two baffle surfaces, wherein:
   each of the one or more baffles forms a single junction with the enclosure, the junction being impermeable to liquid above the bottom of the enclosure;
   each of the one or more baffles optionally forms one or more junctions with one or more other baffles, with each of the one or more junctions being impermeable to liquid above the bottom of the enclosure; and
   any and all junctions formed between each of the one or more baffles and a sealed vessel at a position entirely within the fixture can be made impermeable to liquid above the bottom of the enclosure;
two or more contiguous closed sub-volumes, each being defined by:
   the interior surface of the fixture;
   the sealed vessel positioned entirely within the fixture;
   one or more baffle surfaces; and
   the bottom of the enclosure;
wherein each of the one or more funnels is contiguous with in a single sub-volume, and each of the two or more sub-volumes is contiguous with a single funnel.

In some embodiments, each sub-volume is adjacent to at most two other sub-volumes.

In some embodiments, none of the one or more baffles forms a junction with another baffle.

In some embodiments, at least one of the one or more baffles is impermeable to liquid above the bottom of the enclosure. In some embodiments, each of the one or more baffles is impermeable to liquid above the bottom of the enclosure. In some embodiments, at least one of the one or more baffles is impermeable to liquid above a level located at or below the bottom of the sealed vessel. In some embodiments, each of the one or more baffles is impermeable to liquid above a level located at or below the bottom of the sealed vessel.

In some embodiments, the one or more baffles optionally comprise perforations. In some embodiments, at least one of the one or more baffles comprises perforations. In some embodiments, the perforations are located at or below the bottom of the sealed vessel.

In some embodiments, the burette comprises a graduated section for volumetric displacement measurement.

In some embodiments, the burette at the distal end of the funnel comprises an automated volumetric measuring assembly consisting of a graduated segment of known volume, means to measure the liquid level below the accumulated gas, and means to release the accumulated gas. As an example, this could be implemented through the use of an ultrasonic liquid level sensor, automated valve, and associated control system to actuate the valve when a known gas volume has been accumulated.

In some embodiments, the outlet of the closable valve leads to a device where the accumulated gas composition can be measured using gas chromatography or other suitable method commonly used in the industry for gas composition analysis.

In some embodiments, the testing apparatus further comprises a reservoir, comprising:
one or more liquid-impermeable walls, each containing an interior surface; and
a liquid-impermeable interior surface, defined as the union of the interior surfaces of the one or more liquid-impermeable walls, the interior surface of the enclosure defining a contiguous interior volume of the reservoir sized to receive the lateral dimensions of the enclosure;
wherein the reservoir, the fixture, and the sealed vessel can be positioned such that:
   the bottom of the enclosure is positioned at or above the floor of the reservoir;
   the sealed vessel is within the interior volume of the enclosure; and
   the sealed vessel is also within the interior volume of the reservoir.

In some embodiments, the volume of the medium in the sealed vessel is to be limited through the addition of inert material such as glass spheres to reduce the volume of medium stored in the vessel. In this embodiment, the total amount of a hazardous medium in the test apparatus would be significantly reduced and the pressure response of the system increased for a given mass permeated out of the vessel. In this embodiment, a pressure sensor could be added to the vessel and used as an optional secondary measure of permeation rate.

### Definitions

The term “funnel”, as used herein, alone or in combination, refers to a hollow object with openings to the exterior at opposite ends, with decreasing cross section proceeding from one end to the other end. In some non-limiting embodiments, a funnel has cylindrical symmetry about an axis containing the two openings. In some non-limiting embodiments, a funnel consists of flat sections.

The term “burette”, as used herein, alone or in combination, refers to a vertically oriented tube which is open to the exterior at the bottom, the tube comprising a means for measuring the height of a fluid contained within. In some embodiments, a burette can comprise a transparent window, through which the height of the fluid can be directly observed. In some non-limiting embodiments, the measuring means can include graduations against which liquid level can be visually observed.

The term “contiguous” can be used to describe a single volume characterized in that, for any two points located within the volume, a path can be found between the two points that does not exit the volume. A group of two or more volumes is termed “contiguous” if the volume that is formed by the union of the two or more volumes is contiguous.

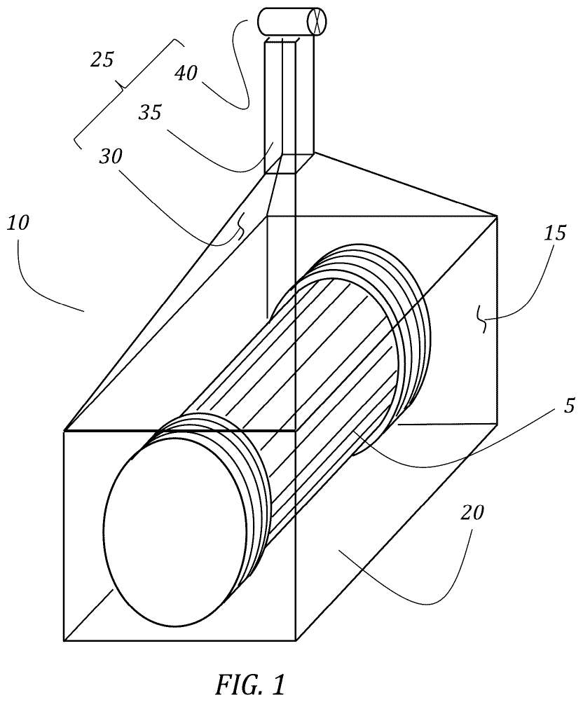

Depicted in FIG. 1 is a perspective of the testing apparatus, in an embodiment of the disclosure. Sealed vessel 5 can be a pipe segment, depicted here lengthwise. Fixture 10 comprises enclosure 15 with opening 20 at its bottom, and funnel assembly 25. In turn, funnel assembly 25 contains funnel 30, burette 35, and closable valve 40. In this embodiment, above opening 20, fixture 10 is impermeable to liquid. The external sides of funnel 30 and burette 35 are also impermeable to liquid.

In the embodiment depicted in FIG. 1, enclosure 15 is a rectangular prism. Opening 20 corresponds to the lower face of the rectangular prism. The upper face of this enclosure 15 is also open. Funnel 30 in this embodiment can be defined geometrically as a prismatoid having trapezoids as lateral faces, and rectangles as upper and lower faces. In this embodiment, the lower face of prismatoid funnel 30 is the open rectangle that constitutes the upper face of enclosure 15. The inner volumes of funnel 30 and enclosure 15 are thereby contiguous. It is not necessary that the funnel completely span the top of the enclosure; however, the top should not contain upward protrusions that could trap bubbles and prevent their migration to a funnel.

In the embodiment depicted in FIG. 1, burette 35 is a rectangular prism elongated in the vertical direction. The lower face of this burette is the open rectangle that constitutes the upper face of prismatoid funnel 30. The inner volumes of burette 35 and funnel 30 are thereby contiguous. By extension, the inner volumes of enclosure 15, funnel 30, and burette 35 are contiguous. Since the lower face of enclosure 15 is open, and both the upper and lower faces of funnel 30 are open, liquids and gases can freely pass between enclosure 15, funnel 30, and burette 35, and the exterior without encumbrance. It will be understood that the embodiment depicted in FIG. 1 is meant to be non-limiting and that burette 35 may have other shapes, such as, without limitation, a cylindrical shape,

Fixture 10 is positioned over sealed vessel 5. Preferably, fixture 10 has sufficient dimensions so that it can encompass the entirety of sealed vessel 5. Testing of elongated vessels such as pipeline segments may be best accommodated with an elongated fixture 10. Enclosures having lengths of up to 40 feet or longer are contemplated. Similarly, transverse and height dimensions are contemplated to allow for testing of pipeline segments from 2″ diameter or smaller up to 48″ or larger. In general, fixture 10 will not be unduly larger than sealed vessel 5, both for convenience of operation and to avoid systematic errors due to, e.g., dissolution of media from the sealed vessel due to its nonzero solubility in water (or other media).

Advantageously but not necessarily, opening 20 has sufficient dimensions to allow fixture 10 to be lowered onto sealed vessel 5. In other embodiments, enclosure 15 may be fitted with doors which are opened to allow entry of sealed vessel into the interior, and which are then partially closed to minimize the size of the opening during testing. The doors may optionally be upward-or downward-opening. It is not necessary for the opening to span the entire bottom of enclosure 15.

It should be noted, however, that the shape and size of enclosure 15, funnel 30, and burette 35 are without limitation, and are determined by mechanical and testing considerations. The walls of enclosure 15 need not be rectangular, or even flat. Outside the requirement for an upward directed taper, the geometry of funnel 30 is similarly unconstrained. Likewise, burette 35 may have any cross-sectional geometry, and need not be uniform in the vertical direction.

In some embodiments, fixture 10 is a single monolithic article of manufacture. In some embodiments, the enclosure 15 and the one or more funnel assemblies 25 are manufactured separately, and are joined subsequent to their manufacture. In some embodiments, interchangeable funnel assemblies can be provided for the testing apparatus, and enclosure 15 can be reversibly joined with different funnel assemblies, depending on the task at hand. Likewise, different burettes, with different capacities and geometries may be employed for particular tasks.

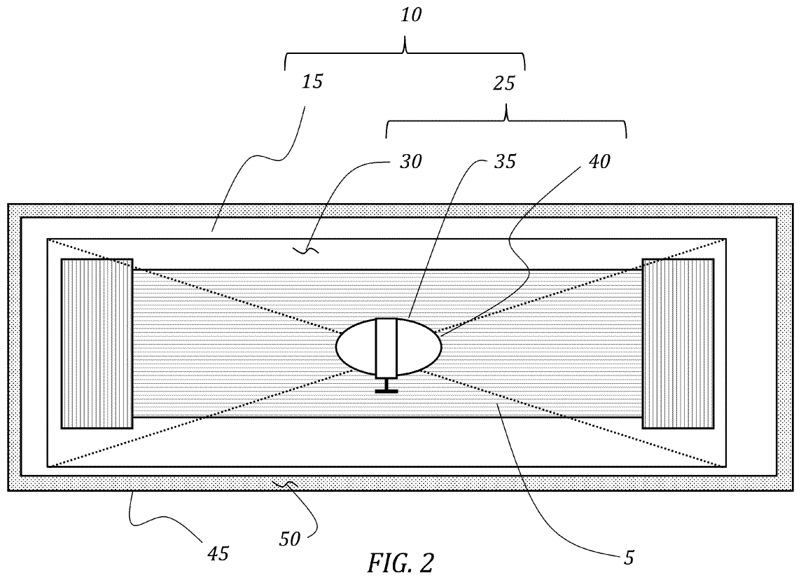

Depicted in FIG. 2 is a top view of the testing apparatus, in an embodiment of the disclosure. Fixture 10 comprises enclosure 15, opening 20 (obscured) and funnel assembly 25. In turn, funnel assembly 25 comprises funnel 30, burette 35, and closable valve 40. In the embodiment depicted in FIG. 2, burette 35 is oval in cross-section. Fixture 10, positioned over sealable vessel 5, is further positioned in reservoir 45, which is sufficiently broad to accommodate the lateral dimensions of fixture 10. Reservoir 45 is fillable with a liquid, preferably water. Optionally, the walls of reservoir 45 contain insulating or heat-regulating material 50.

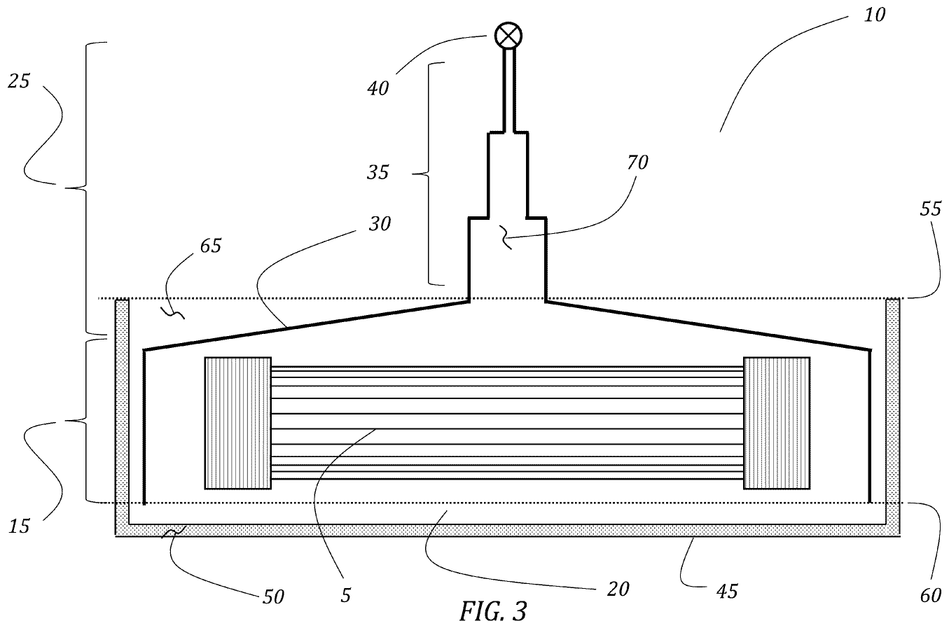

Depicted in FIG. 3 is a side view of the testing apparatus, in an embodiment of the disclosure. Burette 35 in this embodiment comprises three segments with decreasing cross section. Reservoir 45 is sufficiently high to enclose the entirety of sealed vessel 5. In general, reservoir 45 can have any depth below sealed vessel 5 and enclosure 15. In this embodiment, opening 20 of fixture 10 is positioned slightly above the floor of the reservoir. Preferably, the gap is narrow, so as to minimize exchange of water between exterior volume 65 and interior volume 70, that might otherwise lead to systematic error.

Reference will be made to two horizontal planes for describing operation of the testing apparatus. A filling plane 55 can be defined as the highest level to which reservoir 45 can be filled with water, before overtopping the walls. Typically, this plane will represent the height of the walls of reservoir 45. A containment plane 60 can be defined as the level of the highest point on the rim of opening 20. This plane may represent the open lower face of the previously described rectangular prismatic enclosure 15.

Reference will be made to two volumes for describing operation of the testing apparatus. Exterior volume 65, external to fixture 10, extends from the floor of the reservoir to containment plane 60, and further extends outside fixture 10, above containment plane 60, to filling plane 55. Interior volume 70, internal to fixture 10, extends from containment plane 60 upward into enclosure 15, funnel 30, and burette 35. Exterior volume 65 and interior volume 70 are thereby contiguous at containment plane 60. Interior volume 70 will generally enclose the entirety of sealed vessel 5 during testing.

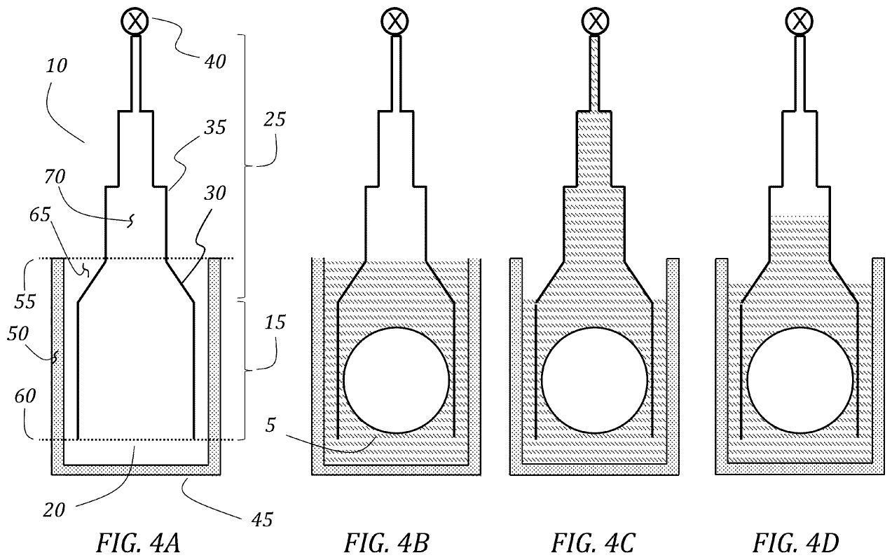

Depicted in FIG. 4A is an end view of the testing apparatus. Fixture 10 comprises enclosure 15, opening 20, and funnel assembly 25. Fixture 10 is further positioned in reservoir 45, which is fillable with a liquid, preferably water, and whose walls optionally contain insulating or heat-regulating material 50.

Sealed vessel 5 is first combined with fixture 10 and liquid in the reservoir. Any particular order for accomplishing this task is contemplated. In some embodiments, fixture 10 is mated with sealed vessel 5, followed by transferring the pair to reservoir. In some embodiments, sealed vessel 5 is first placed in reservoir 45, followed by mounting of fixture 10 on sealed vessel 5. Water can be added in any amount at any time. Preferably, closable valve 40 is in an open state, in order to allow water level to equilibrate both inside and outside of fixture 10.

In some embodiments, a mounting saddle in the reservoir to receive sealed vessel 5 is provided. In some embodiments, an integral and automatic hoisting system for inserting and removing scaled vessel 5, and optionally other peripheral equipment, is provided.

An initial step in the operation of the testing apparatus is depicted in FIG. 4B. The combination of sealed vessel 5 and fixture 10 is immersed in water contained in reservoir 45. Due to opening 20, water will enter enclosure 15. The level of water will be sufficient to completely cover sealed vessel 5. Closable valve 40 can be opened, allowing air to exit the fixture 10 as enclosure 15 fills with water.

A subsequent step in the operation of the testing apparatus is depicted in FIG. 4C. The entirety of fixture 10, up to closable valve 40, is filled with water. In this configuration, therefore, enclosure 15 is filled with water, as is funnel 30 and burette 35 for each funnel assembly 25. In an embodiment, a pump behind closable valve 40 can evacuate air from funnel assembly 25, thereby drawing water into fixture 10, at which point closable valve 40 can be closed. In this embodiment, fixture 10 is impermeable to liquid, so that the level of water within fixture 10 remains constant, absent any introduction of gas within the enclosure.

It is not necessary to completely fill fixture 10 with water, only that the level of water within burette 35 be known before leakage testing. Depending on particulars of design and operation, a void volume may persist at the top of burette 35. This void volume can be a vacuum, due to fixture 10 acting as a fluid manometer, with external barometric pressure being insufficient to support completely a column of water to the top of burette 35. Alternatively, a void volume may be formed from water vapor. In practice, it is not expected that this void volume will meaningfully affect accuracy.

A subsequent step in the operation of the testing apparatus is depicted in FIG. 4D. Sealed vessel 5 is pressurized for testing, preferably once fixture 10 has been filled with water. The combination of the thermal bulk of the water and heat-regulating material 50 will maintain temperature as needed for a particular task. Bubbles in the water environment, formed due to leakage from sealed vessel 5, will rise into enclosure 15 and then into funnel assembly 25, and will eventually combine to form a headspace within burette 35. Fixture 10 will prevent bubbles from escaping into exterior volume 65, and will direct them instead to interior volume 70. Due to their buoyancy, the bubbles will rise and collect to form a gas phase at the upper end of fixture 10, i.e. in burette 35.

Preferably, the lower end of fixture 10 extends beneath the lowest point of sealed vessel 5. Stated more carefully, containment plane 60 is preferentially located beneath the lowest point of sealed vessel 5, thereby preventing bubbles from escaping laterally into exterior volume 65 and escaping measurement. In certain embodiments, depending on the dimensions of enclosure 15 and internal pressure of sealed vessel 5, optimum placement of containment plane 60 may be well below sealed vessel 5, in order to accommodate bubbles that emerge from sealed vessel 5 with significant downward velocity. Conversely, for low-pressure sealed vessel 5 or particularly broad enclosure 15, higher placement of containment plane may be permissible without significant loss of bubbles to the exterior, since lateral movement toward exterior volume 65 will be small, relative to upward movement due to buoyancy.

In some situations, monitoring of exterior volume 65 for bubble formation may be feasible. Alternatively, loss of gas via exterior volume 65 may be estimated. Preferentially, fixture 10 and opening 20 will be designed to as to minimize the frequency, or likelihood, of gas leakage. The air surrounding the testing apparatus can be assayed (intermittently or continuously) for the presence of gaseous media that has escaped out of the apparatus.

Also shown in FIG. 4D is the incorporation of segments of varying cross section into burette 35. This feature allows for precise measurement of early leakage in an upper, narrower segment, followed by convenient measurement over extended time in a lower, wider segment. The number and geometries of segments in burette 35 is without limit, and may be determined by particular testing requirements.

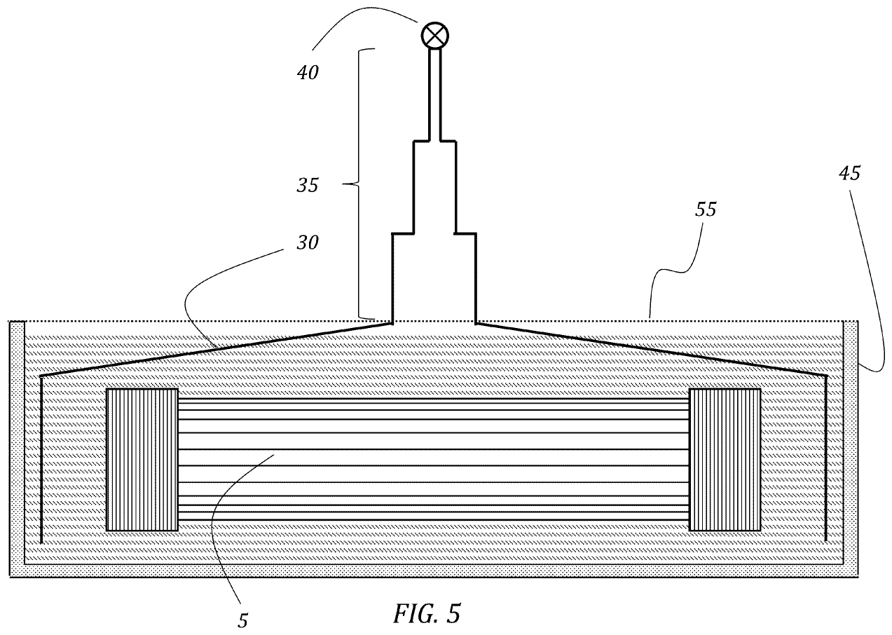

FIGS. 5-7 show side views of the testing apparatus, in an embodiment of the disclosure. Shown in FIG. 5 is an initial state, with reservoir 45 containing sufficient water to cover sealed vessel 5, and pressure equalized inside the fixture, so that water levels are the same both inside and outside of the fixture.

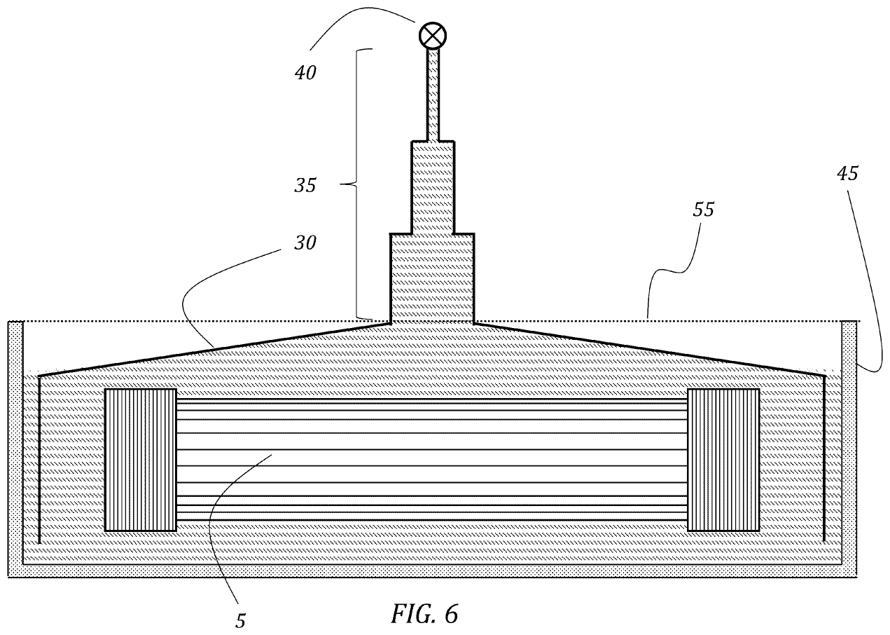

Shown in FIG. 6 is a subsequent state, for which water has been drawn up into the fixture so that burette 35 is filled with water. Suction can be used to draw water from the exterior volume into the interior volume. As depicted in this drawing, water level in the exterior volume will be expected to drop as a result. Large deviations in water level may lead to undesirable variations in hydrostatic pressure within the fixture. Preferably, the reservoir will be sufficiently large, compared to the size of the fixture, so that the drop in water level will not unduly affect performance of the experiment.

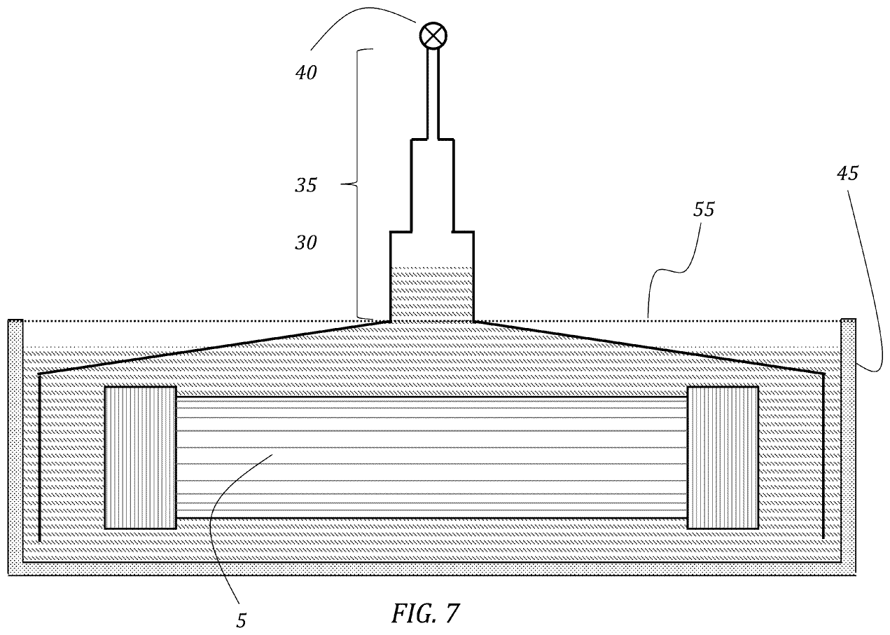

Shown in FIG. 7 is the state of the testing apparatus during a testing run. Gas has entered all three segments of burette 35. At any time, the mass of gas can be found using the ideal gas equation, in combination with the displaced volume, hydrostatic pressure within the fixture and ambient temperature.

In some embodiments, a plurality of funnels is employed to capture leakage from different sections of a sealed vessel. This functionality may be useful for analyzing nonuniform sealed vessels, for which differential permeation might be expected.

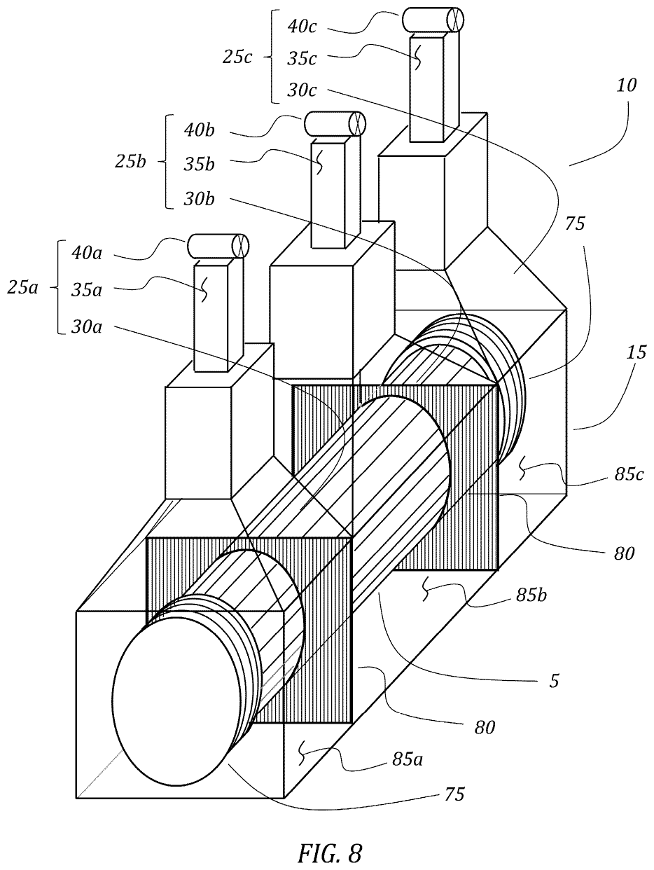

Shown in FIG. 8 is a perspective of an embodiment comprising multiple funnels. The fixture can be used to test differential leakage from sealed vessel 5 comprising two end fittings 75, and comprises three funnel assemblies, labeled from front to back as 25a, 25b, and 25c. Central funnel 30b is positioned over the midsection of the sealed vessel, and funnels 30a and 30c at either end are positioned over end fittings 75. Two baffles 80 subdivide the interior volume into interior sub-volumes 85a, 85b, and 85c, located under funnels 30a, 30b, and 30c, respectively. The baffles serve to direct bubbles from a particular sub-volume into the corresponding funnel for that sub-volume, and block lateral movement of bubbles into an adjacent sub-volume.

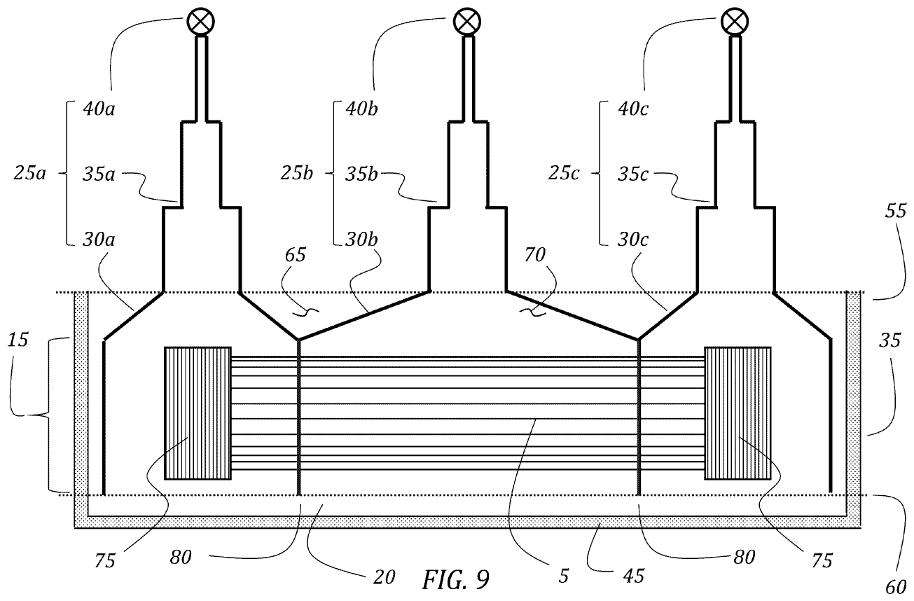

Shown in FIG. 9 is a side view of an embodiment comprising multiple funnels. Generally, baffles 80 will extend well below sealed vessel 5, particularly if leaks can potentially form close to the baffle. In this embodiment, end funnels 30b and 30c are significantly smaller than central funnel 30a, reflecting the small size of end fittings 75 relative to sealed vessel 5 as a whole. The geometries of the burettes need not be identical, nor do their volumes need to be the same: zones that are particularly prone to leakage may be provided with a larger capacity burette, so as to capture the resulting gas without filling the burette. Conversely, zones that are likely to have minimal leakage can be provided with narrower burettes, so as to obtain meaningful data from smaller volumes of gas. Any or all of the burettes may be interchanged, so as to readily evaluate different sealed vessels, or a single sealed vessel under different conditions.

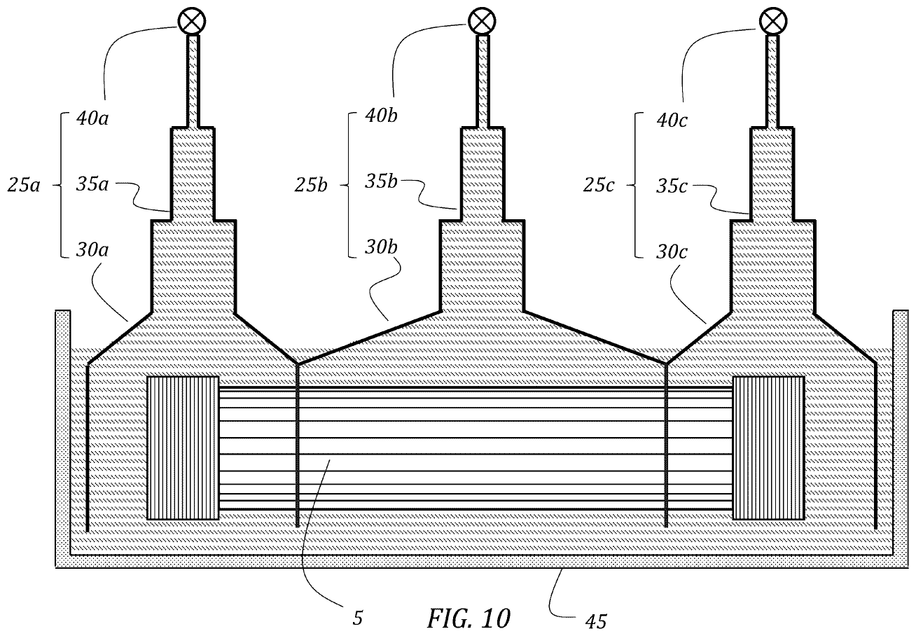

Shown in FIG. 10 is a side view of an embodiment comprising multiple funnels, prior to testing. Each of the three burettes 35a, 35b, and 35c are filled with water. In one embodiment, a pump is fitted behind each of the three closable valves 40a, 40b, and 40c, to evacuate air and draw water into the respective funnel assemblies 25a, 25b, and 25c. Alternatively, a single pump can be used to evacuate air from multiple funnel assemblies simultaneously, with individual funnels being selected for evacuation with closable valves 40a, 40b, and 40c.

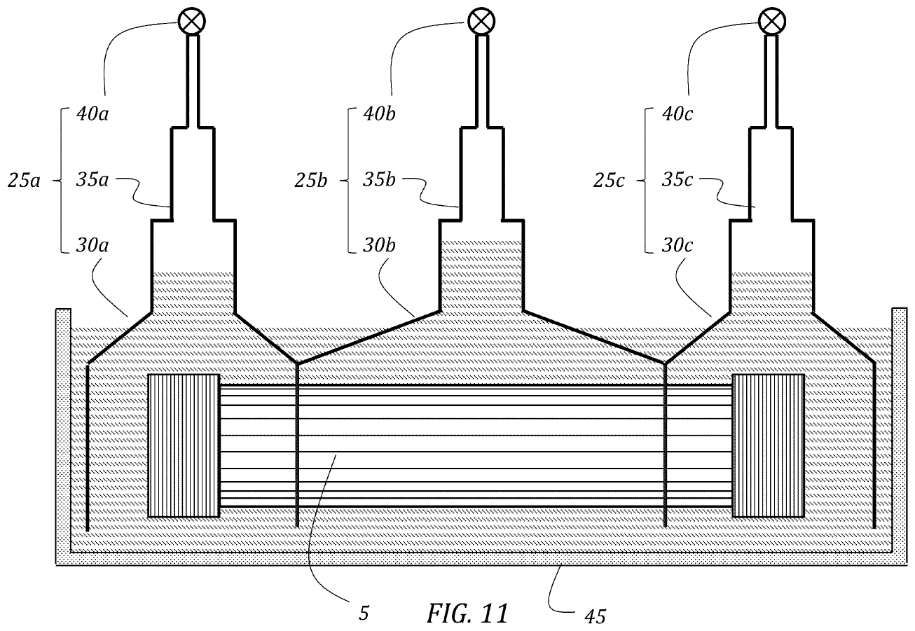

Shown in FIG. 11 is a side view of an embodiment comprising multiple funnels during a testing procedure. It will be noted that the relative height of the water level in the three funnels is not equal, indicating differential collection of gas in the funnels.

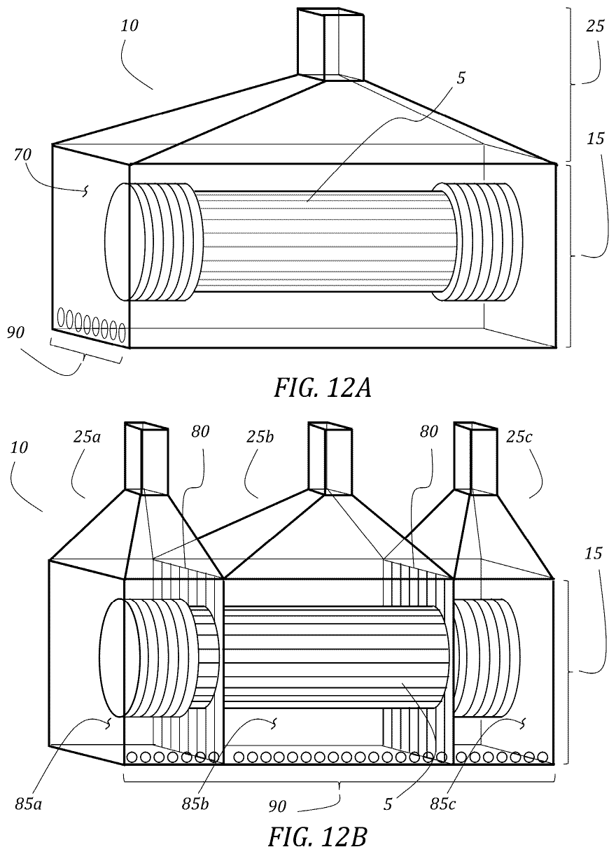

Shown in FIG. 12 are perspectives of embodiments that provide alternate means for exchanging water between the interior volume and the reservoir (not shown).

In the embodiment depicted in in FIG. 12A, fixture 10, comprising enclosure 15 and funnel assembly 25, is positioned over sealed vessel 5. Perforations 90 are located on the bottom left wall of enclosure 15.

Fixtures which are equipped with baffles, and which therefore are partitioned into sub-volumes, must provide a pathway from each of the sub-volumes to the reservoir. This can be accomplished with perforations from each sub-volume in an exterior wall. Flow of water between sub-volumes can be accomplished with perforations in baffles, or the baffles may be manufactured with a gap at the bottom. Any combination of these means may be employed.

Due to the unhindered flow of water between sub-volumes, either below baffles or through perforations contained within baffles, the hydrostatic pressure within each of the sub-volumes will be essentially the same. For this reason, the baffles do not need to have the same mechanical strength as, e.g., the walls of the reservoir.

In the embodiment depicted in FIG. 12B, the corresponding enclosure 15 is equipped with two baffles 80, which divide interior volume into 3 sub-volumes, 85a, 85b, and 85c. These sub-volumes are covered by funnel assemblies 25a, 25b, and 25c, respectively. In this embodiment, perforations 90 are located on the front wall of enclosure 15, grouped in three banks, to allow water in each of the three sub-volumes 85a, 85b, and 85c to flow to the reservoir.

The size, number, and placement of perforations 90 is without limitation. Preferably, the perforations will be located sufficiently below the bottom of sealed vessel 5 to minimize the escape of gas bubbles to the reservoir.

In some embodiments, perforations 90 can be scaled. This may be advantageous for initiating testing. After positioning a sealable vessel in a filled reservoir, a fixture, with each of the one or more closable valve in its open state, is lowered onto the sealable vessel, and forms a water-impermeable junction with the floor of the reservoir. The perforations are then sealed, and water is introduced through each of the closable valves, filling each of the one or more funnel assemblies. The closable valves are then closed, the perforations are unsealed, and the leakage experiment is performed.

Testing conditions can be varied, depending on the type of installation under consideration. In some embodiments, the sealed vessel can be pressurized to up to 15,000 psig. Hydrostatic pressure may be varied by immersing the sealed vessel in a deeper volume of water. In some embodiments, internal and/or external pressure is cycled during a testing run. Preferably, pressure both inside and outside of the sealed vessel will be monitored and recorded during the course of testing.

Temperatures as low as −40° C. and as high as 85° C. and above may be probed, representing both environmental extremes and transient temperature maxima that may be obtained during cycling while in service. Also, temperature may be intentionally cycled during testing. This may be accomplished with proper beat-regulating material 50 within the reservoir.

Temperature control within the testing apparatus can be maintained with a variety of methods. Insulating or heat-regulating material within the walls of the reservoir can assist in maintaining a temperature differential with the environment. In some embodiments, heating or chilling elements can be provided in the floor of the reservoir. Alternatively, pipes containing either heated or chilled fluid can be positioned in the interior volume of the reservoir, preferably in the interior volume of the enclosure.

It will be appreciated that convection due to zones of heated or chilled water may assist with heat transfer within the testing apparatus; however, excessive reliance on convection may lead to temperature gradients, which can detract from thermal equilibrium. Excessive convection may also hamper efforts to contain gas bubbles within the fixture.

In some embodiments, heating or chilling elements can be incorporated into the fixture. This placement may be preferable for chilling, with downward convection of chilled water. Testing of highly pressurized gases may require removal of a significant amount of heat, due to compression of the gas within the sealed vessel.

Some evaluations may require use of a liquid other than water, particularly if the medium in the sealed vessel has appreciable solubility in water. Testing of hydrogen permeability from sealed vessels may be adequately performed with water, due to the low solubility of H₂ in water at standard temperature and pressure.

In some embodiments, additives may be included to water contained in the reservoir. These additives may facilitate testing under extremes of temperature. The additive may be, without limitation, ethylene glycol or propylene glycol, or another suitable organic solvent that can modify the properties of the liquid.

The testing apparatus is amenable to evaluating sealed vessels that carry a flow of media. This may be accomplished by providing suitable end fittings 75 that allow attachment to a source and a drain for media. In some embodiments, a circulating pump is provided. In some embodiments, the media is provided in a closed loop.

While the methods and manufactures have described in detail and with reference to specific examples thereof, it will be apparent to one skilled in the art that various changes and modifications can be made therein without departing from the spirit and scope thereof.

What is claimed is:

1. A testing apparatus for measuring the permeation of a gas from a sealed vessel, the testing apparatus comprising a fixture, the fixture comprising:
an enclosure having an opening located at a bottom of the enclosure; and
one or more funnel assemblies located on a top of the enclosure, each of the one or more funnel assemblies comprising:
a funnel extending vertically from the top of the enclosure, the funnel having a narrow end oriented distal from the enclosure;
a burette located at a distal end of the funnel, the burette comprising a closable valve at a distal end of the burette;
wherein the funnel forms a single liquid-impermeable junction with the enclosure and the burette forms a single liquid-impermeable junction with the funnel;
wherein the fixture includes a liquid impermeable interior surface comprising a union of an interior surface of the enclosure and an interior surface of each of the one or more funnel assemblies, the interior surface of the enclosure defining a contiguous interior volume of the fixture sized to receive an entirety of the sealed vessel.

2. The testing apparatus of claim 1, wherein the enclosure comprises one or more perforations.

3. The testing apparatus of claim 2, wherein the one or more perforations are located at or below the bottom of the sealed vessel.

4. The testing apparatus of claim 1, further comprising a reservoir, the reservoir comprising:
one or more liquid-impermeable walls, each containing an interior surface; and
a liquid-impermeable interior surface, defined as the union of the interior surfaces of the one or more liquid-impermeable walls, the interior surface of the enclosure defining a contiguous interior volume of the reservoir sized to receive the lateral dimensions of the enclosure;
wherein the reservoir, the fixture, and the sealed vessel can be positioned such that:
the bottom of the enclosure is positioned at or above the floor of the reservoir,
the sealed vessel is within the interior volume of the enclosure; and
the sealed vessel is also within the interior volume of the reservoir.

5. The testing apparatus of claim 4, further comprising insulating material in at least one of the one or more walls.

6. The testing apparatus of claim 4, further comprising heat-regulating material in at least one of the one or more walls.

7. The testing apparatus of claim 1, wherein the liquid is water.

8. The testing apparatus of claim 1, wherein each of the one or more funnel assemblies further comprises a pump behind the closable valve.

9. The testing apparatus of claim 1, wherein there exists no spot on the interior surface of the enclosure that is at a local maximum in height.

10. The testing apparatus of claim 1, further comprising:
one or more baffles, each comprising two baffle surfaces, wherein:
each of the one or more baffles forms a single junction with the enclosure, the junction being impermeable to liquid above the bottom of the enclosure;
each of the one or more baffles optionally forms one or more junctions with one or more other baffles, with each of the one or more junctions being impermeable to liquid above the bottom of the enclosure;
any and all junctions formed between each of the one or more baffles and a sealed vessel at a position entirely within the sealed vessel can be made impermeable to liquid above the bottom of the enclosure; and
each of the one or more baffles is impermeable to liquid above the bottom of the enclosure;
two or more contiguous closed sub-volumes, each being defined by:
the interior surface of the fixture;
the sealed vessel positioned entirely within the fixture;
one or more baffle surfaces; and
the bottom of the enclosure;
wherein each of the one or more funnels is contiguous with in a single sub-volume, and each of the two or more sub-volumes is contiguous with a single funnel.

11. The testing apparatus of claim 10, wherein each sub-volume is adjacent to at most two other sub-volumes.

12. The testing apparatus of claim 11, comprising two baffles and three contiguous sub-volumes.

13. The testing apparatus of claim 12, wherein the two baffles each comprise one or more perforations.

14. The testing apparatus of claim 13, wherein the two baffles each comprise one or more perforations located at or below the bottom of the sealed vessel.

15. A method for measuring gas leakage from a sealed vessel, comprising the step of:
providing a fixture, the fixture including an enclosure having an opening located at a bottom of the enclosure and one or more funnel assemblies located on a top of the enclosure, each of the one or more funnel assemblies comprising a funnel extending vertically from the top of the enclosure, the funnel having a narrow end oriented distal from the enclosure and a burette located at a distal end of the funnel, the burette comprising a closable valve at a distal end of the burette, wherein the funnel forms a single liquid-impermeable junction with the enclosure and the burette forms a single liquid-impermeable junction with the funnel, wherein the fixture includes a liquid impermeable interior surface comprising a union of an interior surface of the enclosure and an interior surface of each of the one or more funnel assemblies, the interior surface of the enclosure defining a contiguous interior volume of the fixture sized to receive an entirety of the sealed vessel;
providing a reservoir, the reservoir including one or more liquid-impermeable walls, each containing an interior surface, and a liquid-impermeable interior surface defined as the union of the interior surfaces of the one or more liquid-impermeable walls, the interior surface of the enclosure defining a contiguous interior volume of the reservoir sized to receive the lateral dimensions of the enclosure;
positioning the fixture, the sealed vessel, and an amount of liquid in the reservoir such that:
the bottom of the enclosure is positioned at or above the floor of the reservoir,
the sealed vessel is within the interior volume of the fixture,
the sealed vessel is also within the interior volume of the reservoir; and
the initial level of the liquid in the reservoir is at least as high as the bottom of the fixture, and
the initial amount of the liquid in the interior volume of the fixture is sufficient to completely immerse the sealed vessel; and
observing, over a period of time, a liquid level within the one or more burettes of the testing apparatus.

16. The method of claim 15, wherein the positioning comprises:
positioning the sealed vessel within the interior volume of the reservoir;
positioning the fixture over the sealed vessel such that:
the sealed vessel is within the interior volume of the fixture, and
the bottom of the fixture is positioned at or above the floor of the reservoir;
filling the reservoir with the amount of a liquid such that:
the initial level of the liquid in the reservoir is at least as high as the bottom of the fixture, and
the initial amount of the liquid in the interior volume of the fixture is sufficient to completely immerse the sealed vessel.

17. The method of claim 15, wherein the positioning comprises:
positioning the sealed vessel within the interior volume of the fixture;
positioning the fixture within the reservoir such that the bottom of the fixture is positioned at or above the floor of the reservoir;
filling the reservoir with the amount of a liquid such that:
the initial level of the liquid in the reservoir is at least as high as the bottom of the fixture, and
the initial amount of the liquid in the interior volume of the fixture is sufficient to completely immerse the sealed vessel.

18. The method of claim 15, wherein the sealed vessel is pressurized subsequent to introduction of the liquid into the testing apparatus.

19. The method of claim 15, wherein, prior to observation, the level of the liquid in the interior volume of the fixture is at least as high as the bottom of each of the one or more burettes.

20. The method of claim 15, wherein, prior to observation, each of the one or more burettes is initially full with liquid.

21. The method of claim 15, wherein, prior to observation, none of the one or more burettes initially contains a gaseous headspace.
